(19) United States
(12) Patent Application Publication
(10) Pub. No.: US 2011/0135229 A1
(43) Pub. Date: Jun. 9, 2011

(54) ROLLING BEARING

(75) Inventors: Naoko Ito, Mie (JP); Hideyuki Tsutsui, Mie (JP)

(73) Assignee: NTN Corporation, Osaka-shi, Osaka (JP)

(21) Appl. No.: 12/737,782

(22) PCT Filed: Aug. 28, 2009
(86) PCT No.: PCT/JP2009/065066

§ 371 Date: Feb. 15, 2011

(30) Foreign Application Priority Data
Sep. 5, 2008 (JP) 2008-228966

(51) Int. Cl. F16C 33/56; F16C 9/04

(52) U.S. Cl. 384/457

(57) ABSTRACT

The present invention provides a rolling bearing in which a film formed on a surface of a cage is not likely to dissolve even when the rolling bearing is used in environment where the rolling bearing contacts lubricating oil containing sulfur-based additives and which is excellent in its sliding property and wear resistance. A needle roller bearing (1) has a plurality of needle rollers (3) and a cage (2) retaining the needle rollers (3) and is used in the environment where the rolling bearing contacts the lubricating oil containing the sulfur-based additive. A Ni—B—W film is formed on a surface of the cage (2) the lubricating oil contacts.

### TECHNICAL FIELD

The present invention relates to a rolling bearing and more particularly to a rolling bearing to be used for a connecting rod.

### BACKGROUND ART

The two-cycle engine has a piston making a linear reciprocating motion by combustion of a mixed gas, a crankshaft outputting a rotational motion, and a connecting rod connecting the piston and the crankshaft to each other to convert the linear reciprocating motion to a rotational motion. The connecting rod has a large-end portion at a lower portion of a straight rod and a small-end portion at an upper portion thereof. The crankshaft and a piston pin coupling the piston and the connecting rod to each other are rotatably supported at the large-end portion of the connecting rod and at the small-end portion of the connecting rod respectively via roller bearings mounted on engaging holes respectively. The roller bearing supporting the rotational shaft is constructed of a plurality of rollers and a cage retaining the rollers.

The roller bearings, mounted on the engaging holes formed at the small-end portion of the connecting rod and at the large-end portion thereof respectively, which support the piston pin and the crankshaft respectively are capable of receiving a high load, although a projected area thereof is small. As the roller bearing, a needle roller bearing having a high rigidity is used. The needle roller bearing includes a plurality of needle rollers and a cage retaining a plurality of the needle rollers. The cage is provided with pockets for retaining the needle rollers respectively. Columnar portions each positioned between the pockets retain the interval between the needle rollers. To decrease a load applied to the needle roller bearing owing to rotations of the needle rollers and rotations thereof about the center of the cage, the needle roller bearings disposed at the small-end portion of the connecting rod and at the large-end portion thereof respectively are used by guiding the needle roller bearings along the outside-diameter surface of the cage by positively bringing the outside-diameter surface of the cage into contact with the inside-diameter surfaces of the engaging holes formed at the small-end portion of the connecting rod and at the large-end portion thereof respectively.

On the other hand, the inside of an ordinary rolling bearing is sealed with an inner ring, an outer ring, and a sealing member. The inside of the bearing is provided with rolling elements and a cage. Grease is filled inside the bearing. The rolling elements and the cage are always lubricated with the grease. On the other hand, because the above-described needle roller bearing is provided with none of the inner ring, the outer ring, and the sealing member, the inside of the bearing is not sealed, and the grease cannot be filled inside the bearing. Therefore when the needle roller bearing rotates, it is necessary to always supply lubricating oil to a sliding portion by a pump or the like.

Because the pump and the like start to operate simultaneously with the start of the rotation of the needle roller bearing, the lubricating oil does not spread to the entire needle roller bearing immediately after the needle roller bearing starts to rotate. Thus a sufficient lubrication is not accomplished. Therefore a large friction is generated between the cage and the needle rollers. Thereby wear occurs on the surface of the cage and those of the needle rollers and on the outside-diameter surface of the cage and the inner-diameter surface of the housing of an apparatus. In the worst case, there is a fear that both seize on each other. Therefore to prevent wear and seizing which occur immediately after the needle roller bearing starts to rotate, an art of forming a film having lubricity on the surface of the cage in advance is proposed.

For example, a method of forming a hard film of diamond-like carbon (hereinafter referred to as DLC) by a carburizing process on the guide surfaces of the rolling elements of the cage, made of the steel material, which has the hard layer formed on the surface thereof by using a sputtering method and thereafter forming a film of a soft metal such as silver on the film of the DLC (see patent document 1) is known. According to the description made in the patent document 1, because the film of the soft metal decreases the friction between the cage and the needle roller and the friction between the outside-diameter surface of the cage and the inside-diameter surface of the housing, it is possible to prevent the seizing of the cage and the needle roller even at the time immediately after the needle roller bearing starts to rotate, although a sufficient lubrication is not accomplished for the needle roller bearing at this time. Further even though the film of the soft metal wears with the use of the needle roller bearing, the DLC film disposed under the film of the soft metal is newly exposed outside and prevents the wear.

An art of directly forming the film of the soft metal on the surface of the cage by a plating method is proposed. For example, a method of forming a film, consisting of plated silver, which has a thickness of 25 to 50 μm on the surface of low carbon steel is known (see patent document 2). According to the description made in the patent document 2, because the film consisting of the plated silver decreases the friction between the cage and the needle rollers and the friction between the outside-diameter surface of the cage and the housing, as described above, the occurrence of the seizing can be prevented even at the time immediately after the needle roller bearing starts to rotate although a sufficient lubrication is not accomplished for the needle roller bearing at this time. According to the description made therein, similarly to the film consisting of the plated silver, because the film consisting of the plated copper has also an action of decreasing the friction between the cage and the needle rollers, the film consisting of the plated copper is capable of preventing the seizing.

### PRIOR ART DOCUMENT

### Patent Document

Patent document 1: Japanese Patent Application Laid-Open No. 2005-147306
Patent document 2: Japanese Patent Application Laid-Open No. 2002-195266

### SUMMARY OF THE INVENTION

### Problem to be Solved by the Invention

But in the method described in the patent document 1, after the soft metal wears out, the hard film is exposed outside, and the inside-diameter portion of the housing and the hard film slide on each other. In this case, although the cage does not wear, there is a fear that the inside-diameter portion of the housing is worn by the hard film formed on the surface of the cage. From the standpoint of the production, because the carburizing processing is carried out on the cage, the DLC film is formed by a sputtering apparatus, and the soft metal film is formed, operation steps are complicated, and many steps are required. Further the sputtering apparatus is expensive and provides unfavorable production efficiency. Therefore the processing to be performed by using the sputtering apparatus costs high.

In the method described in the patent document 2, in the lubricating system containing the sulfur-based additive, the film, consisting of the plated silver, which has been formed on the surface of the cage binds with the sulfur component contained in the lubricating oil to form silver sulfide. The silver sulfide coats the surface of the film consisting of the plated silver. Because the silver sulfide is frailer than silver, the film peels or is inferior in its oil resistance. Thus the film dissolves in the lubricating oil. Consequently there occurs a problem that the friction between the outside-diameter surface of the cage on which the film consisting of the plated silver has worn out and the inside-diameter surface of the housing increases and thus the seizing tends to occur. Similarly, the film consisting of the plated silver binds with the sulfur component to form copper sulfide, which poses a problem that owing to the peeling and dissolution of the film, the lubricity of the cage deteriorates.

The present invention has been made to cope with the above-described problems. It is an object of the present invention to provide a rolling bearing in which a film formed on a surface of a cage is not likely to dissolve even when the rolling bearing is used in environment where the rolling bearing contacts lubricating oil containing sulfur-based additives and which is excellent in its sliding property and wear resistance.

### Means for Solving the Problem

The rolling bearing of the present invention has a plurality of rolling elements and a cage retaining the rolling elements. A Ni—B—W film is formed on a surface of the cage. The rolling bearing is used in environment where the rolling bearing contacts lubricating oil containing sulfur-based additives. The surface of the cage on which the Ni—B—W film is formed is a portion the lubricating oil contacts.

In compositions of the Ni—B—W film, B is 0.3 to 1.3 atomic % and W is 0.1 to 1.1 atomic %. A thickness of the Ni—B—W film is 3 to 100 μm.

The cage is a consists of an iron-based metal material. The iron-based metal material is bearing steel, carburized steel, carbon steel for machine structural use, cold rolled steel or hot rolled steel.

The rolling element is roller-shaped. The rolling element is needle roller-shaped.

When three specimens each consisting of an SCM415 base material, having a dimension of 3 mm×3 mm×20 mm, on which the Ni—B—W film has been formed are immersed in 2.2 g of poly-α-olefin oil containing 1 wt % of zinc dithiophosphate at 150° C. for 200 hours, a component of the Ni—B—W film does not elute from the specimens.

The rolling bearing of the present invention is a roller bearing supporting a crankshaft outputting a rotational motion, being mounted on an engaging hole formed at a large-end portion of a connecting rod converting a linear reciprocating motion to a rotational motion, and being guided along an outside-diameter surface of the cage.

### Effect of the Invention

The rolling bearing of the present invention has a plurality of rolling elements and the cage retaining the rolling elements, and the Ni—B—W film is formed on the surface of the cage. Therefore the surface of the cage has a friction coefficient equal to or lower than that of a conventional film consisting of a plated metal. Even when the rolling bearing is used in the environment in which the rolling bearing contacts the lubricating oil containing the sulfur-based additive, it is possible to suppress the peeling of the film and the dissolution of the component of the film into the lubricating oil and maintain the lubricity of the cage for a longer term than the conventional film consisting of the plated metal.

Because the rolling elements are roller-shaped, the rolling bearing is capable of receiving a high load. By using the needle roller bearing having a high rigidity as the rolling-bearing, the rolling bearing is capable of receiving a higher load.

The rolling bearing of the present invention supports the crankshaft outputting the rotational motion, is mounted on the engaging hole formed at the large-end portion of the connecting rod converting the linear reciprocating motion to the rotational motion, and guided along the outside-diameter surface of the cage. Therefore the above-described film is capable of maintaining the lubricity of the cage for a longer term than the conventional film consisting of the plated metal, and the friction of the outside-diameter surface of the cage and that of the inside-diameter surface of the engaging hole are prevented. Thereby the entire apparatus is allowed to have a long life.

### BRIEF DESCRIPTION OF THE DRAWINGS

FIG. 1 is a vertical sectional view of a two-cycle engine in which a rolling bearing of the present invention is used.

FIG. 2 is a perspective view showing a needle roller bearing which is one embodiment of the rolling bearing of the present invention.

FIG. 3 shows a sliding testing machine.

### BEST MODE FOR CARRYING OUT THE INVENTION

As a result of energetic studies of a rolling bearing which is used in environment where the rolling bearing contacts lubricating oil containing a sulfur component, it has been found that a Ni—B—W film formed on a surface of a cage by electroless plating instead of a conventional film consisting of plated copper or silver is capable of maintaining the friction coefficient of the surface of the cage equal to or lower than that of conventional film consisting of silver or the like and that the component of the film is not likely to dissolve in the lubricating oil containing the sulfur component, when the Ni—B—W film is immersed therein. The present invention is based on this finding.

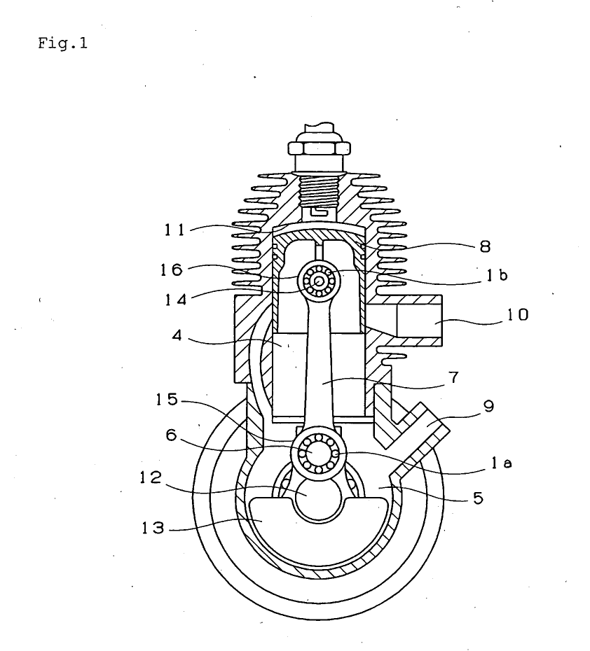

The use form of the rolling bearing of the present invention is described below with reference to the drawings. FIG. 1 is a vertical sectional view of a two-cycle engine using a needle rolling bearing as the rolling bearing of the present invention. As shown in FIG. 1, the two-cycle engine has a piston 8 making a linear reciprocating motion by the combustion of a mixed gas of gasoline and lubricating oil which is engine oil, a crankshaft 6 outputting a rotational motion, and a connecting rod 7 connecting the piston 8 and the crankshaft 6 to each other to convert the linear reciprocating motion to the rotational motion. The crankshaft 6 rotates on a rotational central shaft 12. A balance weight 13 takes balance in the rotation.

The connecting rod 7 has a large-end portion 15 at a lower portion of a straight rod and a small-end portion 16 at an upper portion thereof. The crankshaft 6 is rotatably supported via a needle roller bearing 1a mounted on an engaging hole of the large-end portion 15. A piston pin 14 coupling the piston 8 and the connecting rod 7 to each other is rotatably supported via a needle roller bearing 1b mounted on an engaging hole of the small-end portion 16. After the mixed gas of the gasoline and the lubricating oil is fed from an inlet hole 9 to a crankcase 5, the mixed gas is introduced into a combustion chamber 11 disposed above a cylinder 4 according to a vertical motion of the piston 8 and burnt. A burnt exhaust gas is discharged from an exhaust hole 10.

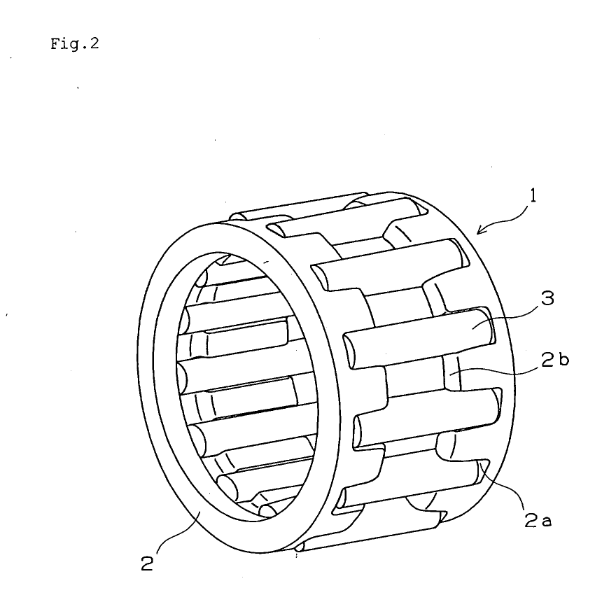

FIG. 2 is a perspective view showing a needle roller bearing which is one embodiment of the rolling bearing of the present invention. As shown in FIG. 2, a needle roller bearing 1 is constructed of a plurality of needle rollers 3 and a cage 2 retaining the needle rollers 3 at regular or irregular intervals. The needle roller bearing is not provided with an inner ring nor an outer ring. The crankshaft 6 and the piston pin 14 are directly inserted into the inside-diameter side of the cage 2. The outside-diameter side of the cage 2 is fitted in the engaging hole, of the connecting rod 7, which is a housing (see FIG. 1). Because the needle roller bearing 1 does not have the inner ring nor the outer ring and because the needle rollers 3 each having a small diameter relative to its length are used as its rolling element, the needle roller bearing 1 is smaller than ordinary rolling bearings having the inner and outer rings.

The cage 2 is provided with pockets 2a for holding the needle rollers 3 respectively. Each columnar portion 2b disposed between the pockets holds an interval between the needle rollers 3. A film which is described later is formed on the surface of the cage 2. The surface of the cage on which the film is formed contacts the lubricating oil. It is preferable to form the film on the entire surface of the cage 2 including the surfaces of the pockets 2a which contact the needle rollers 3. In addition to the surface of the cage 2, it is possible to form a similar film on the surfaces of the needle rollers 3 which are the rolling elements of the needle roller bearing.

The rolling bearing of the present invention is applicable to environment in which the rolling bearing contacts the lubricating oil containing a sulfur-based additive. As the environment in which the rolling bearing contacts the lubricating oil, as described above, it is possible to list a case in which the rolling bearing mounted on the connecting rod of the two-cycle engine or that of a four-cycle engine contacts the mixed gas of the gasoline and the lubricating oil which is the engine oil or the engine oil and a case in which the rolling bearing contacts oil when the pockets of the cage thereof are lubricated.

The sulfur-based additive means an additive containing a sulfur-based compound. As the kind of the additive, an antioxidant, an anti-corrosive agent, an extreme-pressure agent, a detergent-dispersant, a metal deactivator, an anti-wear agent, and the like are listed. As the lubricating oil to which the additive containing the sulfur-based compound is added, mineral oil, synthetic oil, ester oil, ether oil, and the like are listed.

As the sulfur-based compound, it is possible to list thiophosphate such as zinc dialkyl dithiophosphate (hereinafter referred to as ZnDTP) and zinc diallyl dithiophosphate, terpene sulfide, phenothiazine, mercaptobenzothiazole, oil sulfonate, alkylbenzene sulfonate, a salt of a reaction product of polybutene-P₂S₅, ammonium salts of organic sulfonic acid, organic sulfonates of alkali earth metals; mercapto fatty acids such as 1-mercapto stearate and metal salts thereof; thiazoles such as 2,5-dimercapto-1,3,4-thiadiazole, 2-mercaptothiadiazole; disulfide compounds such as 2-(decyldithio)-benzimidazole, 2,5-bis(dodecyldithio)-benzimidazole; thiocarboxylic ester compounds such as dilauryl thiopropionate; sulfide grease such as dibenzyl disulfide, diphenyl disulfide, sulfurized sperm oil; ester sulfide such as sulfurized olefin, sulfurized fatty ester; sulfide such as dibenzyl disulfide, alkyl polysulfide, olefin polysulfide; calcium sulfonate; magnesium sulfonate; and alkyl dithiophosphateamine. Of the above-described sulfur-based compounds, a compound which easily gives influence on the roller bearing for the connecting rod is the ZnDTP.

In the present invention, “peeling or dissolution is not likely to occur in the environment in which the rolling bearing contacts the lubricating oil containing the sulfur-based additive” means that when three specimens each consisting of an SCM415 base material, having a dimension of 3 mm×3 mm×20 mm (surface area: 258 mm²), on which the above-described film has been formed are immersed in 2.2 g of poly-α-olefin oil (PAO) containing 1 wt % of the ZnDTP at 150° C. for 200 hours, the amount of the components of the films which have eluted in the lubricating oil from the specimens is not more than 200 ppm, when the amount the components of the films are measured by an X-ray fluorescence measurement apparatus.

The film to be formed on the cage of the rolling bearing of the present invention is the Ni—B—W film. The Ni—B—W film is formed on the surface of the cage by electroless plating treatment. The electroless plating is capable of making the thickness of the film uniform and is excellent in a dimensional accuracy and is capable of uniformly dispersing added fine powder in the film.

The Ni—B—W film is a composite film of Ni (nickel), B (boron), and W (tungsten). As the composition of the Ni—B—W film, it is preferable that Ni is 93.8 to 94.8 atomic %, B is 0.3 to 1.3 atomic %, and W is 0.1 to 1.1 atomic %. Because the Ni—B—W film is harder than the Ni—P film and superior thereto in the sliding property and wear resistance thereof, the Ni—B—W film is possible to prevent the outside-diameter surface of the cage and the inner-diameter surface of the housing (engaging hole) from wearing. In addition as shown in the examples of the present invention described later, even in the environment where the rolling bearing contacts the lubricating oil containing the sulfur-based additive, the component of the film is not likely to elute. As a commercially available product of the Ni—B—W film, protonics system JA (commercial name) produced by NIHON PROTON Co., LTD is exemplified.

The thickness of the Ni—B—W film to be formed on the surface of the cage is favorably 3 to 100 μm and more favorably 5 to 60 μm. When the thickness thereof is less than 3 μm, there is a possibility that the film wears out owing to an initial wear. When the thickness thereof is more than 100 μm, the roundness of the cage deteriorates, which is unpreferable.

Because the cage having the film formed on the surface thereof is used for the rolling bearing of the present invention, it is possible to use bearing steel, carburized steel, carbon steel for machine structural use, cold rolled steel or hot rolled steel for the body of the cage. Of these steels, it is preferable to use the carburized steel having a high heat resistance and a rigidity resistant to a high load. As the carburized steel, it is possible to exemplify SCM415.

Because the rolling element for use in the rolling bearing of the present invention is roller-shaped, the rolling bearing of the present invention is mounted on the engaging hole formed at the small-end portion of the connecting rod and the large-end portion thereof and is capable of supporting the piston and the crankshaft. In addition the rolling bearing is capable of receiving a high load, although the projected area thereof is small. Particularly the rolling bearing using the needle roller having a high rigidity as the rolling element thereof is capable of receiving a higher load than a rolling bearing using a roller as the rolling element thereof.

The rolling bearing of the present invention is the roller bearing which supports the crankshaft outputting the rotational motion, is mounted on the engaging hole formed at the large-end portion of the connecting rod converting the linear reciprocating motion to the rotational motion, and is guided along the outside-diameter surface of the cage having the above-described film formed thereon. Therefore the film little peels, and the metal component thereof little elutes in the lubricating oil. Thus the film formed on the cage is capable of maintaining the lubricity of the cage for a longer period of time than that of a conventional film consisting of a plated metal. Further the wear of the outside-diameter surface of the cage and the inside-diameter surface of the engaging hole are prevented. Thereby the entire apparatus is allowed to have a long life.

As shown in FIG. 1, the rolling bearing of the present invention supports the piston pin outputting the linear reciprocating motion and can be mounted on the engaging hole formed at the small-end portion of the connecting rod converting the linear reciprocating motion to the rotational motion.

In addition to the needle roller bearing for the connecting rod, the construction of the rolling bearing of the present invention is applicable to a ball bearing, an angular contact ball bearing, a cylindrical roller bearing, and a tapered roller bearing.

### EXAMPLES

### Example 1

Three SCM415 plate-shaped base materials each having a dimension of 3 mm×3 mm×20 mm (surface area: 258 mm²) and one SUJ2 ring-shaped base material having a dimension of an outer diameter of 40 mm×an inner diameter of 20 mm×a thickness of 20 mm (sub-curvature R: 60 mm) were subjected to electroless plating by using Ni—B—W plating (protonics system JA produced by NIHON PROTON Co., LTD, B: 0.85 atomic %, W: 0.60 atomic %, and Ni: 94.27 atomic %) to form a Ni—B—W film having a thickness of 10 μm. Thereby plate-shaped specimens and a ring-shaped specimen were obtained. The plate-shaped specimens and the ring-shaped specimen were subjected to a lubricating oil immersion test shown below and to a sliding test shown below to measure the amount of components of the films which dissolved in lubricating oil and the friction coefficients of the films. Table 1 shows the results.

### <Lubricating Oil Immersion Test>

After the three specimens were immersed in 2.2 g of PAO oil (LUCANT HC-10 produced by Mitsui Chemicals, Inc.) containing 1 wt % of the ZnDTP (LUBRIZOL 677A produced by Lubrizol Corporation) for 200 hours at 150° C., the amount of the components of the films which eluted from the specimens in the lubricating oil were measured by using an X-ray fluorescence measurement apparatus (Rigaku ZSX100e produced by Rigaku Corporation).

### <Sliding Test>

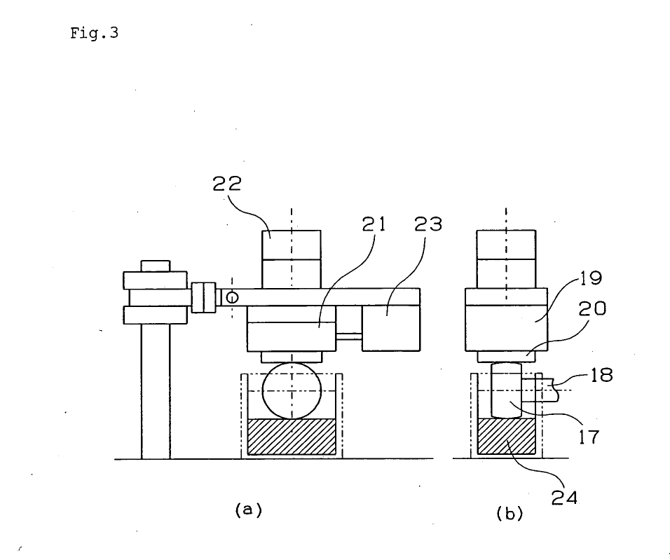

A sliding testing machine (Savin type frictional wear testing machine) shown in FIG. 3 was used. FIG. 3(a) and FIG. 3(b) show a front view and a side view respectively. A ring-shaped specimen 17 is mounted on a rotational shaft 18, and a steel plate 20 is fixed to an air slider 21 of an arm portion 19. While a predetermined load 22 is being applied to the ring-shaped specimen 17 from an upper portion in FIG. 3, the ring-shaped specimen 17 contacts the steel plate 20 with the ring-shaped specimen 17 rotating. Lubricating oil is supplied to an outside-diameter surface of the ring-shaped specimen 17 from a felt pad 24 impregnated with the lubricating oil. A frictional force generated when the ring-shaped specimen 17 is rotated is detected by a load cell 23. As the steel plate 20, a carburized steel SCM415 quenched and tempered (Hv 700) was used. As the lubricating oil, Mobil Velocity Oil No. 3 (VG2 produced by Exxon Mobil Corporation) was used. The load was 50N. The sliding speed is 5 m/second. The test period of time is 30 minutes. The friction coefficient was indicated as an average of values measured for 10 minutes before the test finished.

### Comparative Example 1

Except that a copper film having a thickness of 5 μm was formed as a base film instead of the Ni—B—W film by performing copper plating treatment, and thereafter a silver film having a thickness of 25 μm was formed, treatment similar to that of the example 1 was carried out, and an obtained specimen was subjected to a test and measurement similar to those of the example 1. Table 1 shows the results.

### Comparative Example 2

Except that a copper film having a thickness of 30 μm was formed instead of the Ni—B—W film by performing copper plating treatment, treatment similar to that of the example 1 was carried out, and an obtained specimen was subjected to a test and measurement similar to those of the example 1. Table 1 shows the results.

### Comparative Example 3

Except that a Ni—P film having a thickness of 10 μm was formed instead of the Ni—B—W film by performing Ni—P electroless plating treatment, treatment similar to that of the example 1 was carried out, and an obtained specimen was subjected to a test and measurement similar to those of the example 1. Table 1 shows the results.

TABLE 1

| | | Comparative | Comparative | Comparative |
|---|---|---|---|---|
| | Example 1 | example 1 | example 2 | example 3 |
| Measured | Nickel | Silver | Copper | Nickel |
| elements | | | | |
| Dissolution | 0 | 600 | 3500 | 0 |
| amount, ppm | | | | |
| Friction | 0.03 | 0.03 | 0.08 | — ¹⁾ |
| coefficient | | | | |

¹⁾ The specimen vibrated greatly during the test and thus the operation of the sliding testing machine was manually stopped.

As shown in table 1, in the lubricating oil immersion test, the metal components of the conventional films of the specimens of the comparative examples 1 and 2 consisting of the plated metals dissolved in the lubricating oil. The dissolution amount of the plated copper was large. Although the metal component of the Ni—P film of the specimen of the comparative example 3 did not dissolve, its sliding property and wear resistance were inferior. Thereby the specimen vibrated greatly during the test and thus the test was stopped. On the other hand, the Ni—B—W film of the specimen of the example 1 had a friction coefficient equal to or lower than that of the conventional film consisting of the plated metal or metals and in addition the metal component of the Ni—B—W film did not dissolve.

### INDUSTRIAL APPLICABILITY

Because the predetermined film is formed on the surface of the cage of the rolling bearing of the present invention, the rolling bearing is capable of maintaining the lubricity of the cage for a long period of time in the environment where the rolling bearing contacts the lubricating oil containing the sulfur-based additive. Thus the rolling bearing can be preferably used in this environment.

### EXPLANATION OF REFERENCE NUMERALS AND SYMBOLS

1: needle roller bearing (rolling bearing)
1a: needle roller bearing
1b: needle roller bearing
2: cage
2a: pocket portion
2b: columnar portion
3: needle roller (rolling element)
4: cylinder
5: crankcase
6: crankshaft
7: connecting rod
8: piston
9: inlet hole
10: exhaust hole
11: combustion chamber
12: rotational central shaft
13: balance weight
14: piston pin
15: large-end portion
16: small-end portion
17: ring-shaped specimen
18: rotational shaft
19: arm portion
20: steel plate
21: air slider
22: load
23: load cell
24: felt pad

1. A rolling bearing comprising a plurality of rolling elements and a cage retaining said rolling elements,
wherein a Ni—B—W film is formed on a surface of said cage.

2. A rolling bearing according to claim 1, which is used in environment where said rolling bearing contacts lubricating oil containing sulfur-based additives, wherein said surface of said cage on which said Ni—B—W film is formed is a portion said lubricating oil contacts.

3. A rolling bearing according to claim 1, wherein in compositions of said Ni—B—W film, B is 0.3 to 1.3 atomic % and W is 0.1 to 1.1 atomic %.

4. A rolling bearing according to claim 1, wherein a thickness of said Ni—B—W film is 3 to 100 μm.

5. A rolling bearing according to claim 1, wherein said cage is a molded article of an iron-based metal material.

6. A rolling bearing according to claim 5, wherein said iron-based metal material is bearing steel, carburized steel, carbon steel for machine structural use, cold rolled steel or hot rolled steel.

7. A rolling bearing according to claim 1, wherein said rolling element has a roller configuration.

8. A rolling bearing according to claim 7, wherein said roller configuration is a needle roller configuration.

9. A rolling bearing according to claim 1, wherein when three specimens each consisting of an SCM415 base material, having a dimension of 3 mm×3 mm×20 mm, on which said Ni—B—W film has been formed are immersed in 2.2 g of poly-α-olefin oil containing 1 wt % of zinc dithiophosphate at 150° C. for 200 hours, a component of said Ni—B—W film does not dissolve from said specimens.

10. A rolling bearing according to claim 1, which is a roller bearing supporting a crankshaft outputting a rotational motion, being mounted on an engaging hole formed at a large-end portion of a connecting rod converting a linear reciprocating motion to a rotational motion, and being guided along an outside-diameter surface of said cage.
